(19) United States
(12) Patent Application Publication
(10) Pub. No.: US 2024/0300344 A1
(43) Pub. Date: Sep. 12, 2024

(54) AUTOMATED CHARGING PORT CLOSURE ACTUATION

(71) Applicant: Rivian IP Holdings, LLC, Plymouth, MI (US)

(72) Inventors: Kostandinos PAPANIKOLAOU, Corona, CA (US); Thorsten LUEDTKE, Orange, CA (US); Shukan Shitalkumar Parekh, Costa Mesa, CA (US)

(21) Appl. No.: 18/118,645

(22) Filed: Mar. 7, 2023

(51) Int. Cl. B60L 53/16; B60L 58/12

(52) U.S. Cl. CPC B60L 53/16; B60L 58/12; B60L 2250/22

(57) ABSTRACT

Aspects of the subject disclosure relate to automatic actuation of a vehicle charging port closure based on one or more detections. A device implementing the subject technology may include at least one processor configured to detect conditions such as a battery charge state, a proximity to a charger, an elapsed time since last charge, and/or whether the charging station is one at which charging is frequently performed. Such detections can form the basis of a determination that the user is likely to utilize the charging port, and the vehicle and provide automatic actuation. Accordingly, automatic handsfree opening of the charging port closure can be provided.

### INTRODUCTION

Vehicles, including electric vehicles, can include a charging port for charging a battery of the vehicle. For example, the charging port can be configured to receive a connector of a charging station that provides electrical power.

### SUMMARY

The present description relates generally to the automatic actuation (e.g., opening) of a vehicle charging port closure in preparation for charging a battery of a vehicle at a charging port. The subject system determines whether to actuate a charging port closure based on one or more factors. For example, the vehicle may analyze battery data, such as a battery charge state and/or an amount of time since the battery was last charged. By further example, the vehicle may further analyze location data, such as a location of the vehicle with respect to a charging station and/or whether the charging station is one at which charging is frequently performed. By further example, the vehicle may further analyze user data, such as identifying an authorized user, determine a position and/or movement of the user with respect to the charging port closure, and/or whether the user is holding a connector configured to connect to a charging port covered by the charging port closure. Where historical user charging port closure actuation data indicates that such factors, when present, indicate that the authorized user is likely to utilize the charging port, then the vehicle may determine that actuation of the charging port closure is appropriate.

In accordance with one or more aspects of the disclosure, a method includes obtaining, by a processor, sensor data from at least one sensor of a vehicle; determining, by the processor, a likelihood that an authorized user of the vehicle will utilize a charging port of the vehicle based at least in part on the sensor data; and causing, by the processor, an actuation to open the charging port closure based on the likelihood.

In accordance with one or more aspects of the disclosure, a semiconductor device is provided that includes circuitry configured to obtain battery data corresponding to a battery of a vehicle, the battery data comprising a battery charge state of the battery and an amount of time since the battery was last charged; determine a likelihood that an authorized user of the vehicle will utilize a charging port of the vehicle based at least in part on the battery data; and cause an actuation to open the charging port closure based on the likelihood.

In accordance with one or more aspects of the disclosure, a non-transitory machine-readable medium is provided that stores instructions that, when executed by one or more processors, cause the one or more processors to perform operations including: obtaining sensor data from at least one sensor of a vehicle, the sensor data corresponds to a condition of a battery of the vehicle and a location of the vehicle; determining a likelihood that an authorized user of the vehicle will utilize a charging port of the vehicle based at least in part on the sensor data; and causing an actuation to open the charging port closure based on the likelihood.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example vehicle in an environment including a user and a charging station in accordance with one or more implementations of the subject technology.

FIG. 2 illustrates a block diagram of an example vehicle configured to perform automatic charging port closure actuation based on one or more detections in accordance with one or more implementations of the subject technology.

FIG. 3 illustrates a flow diagram of an example process flow for automatic charging port closure actuation based on one or more detections in accordance with one or more implementations of the subject technology.

FIG. 4 illustrates a flow diagram of an example process for automatic charging port closure actuation based on one or more detections in accordance with one or more implementations of the subject technology.

FIG. 5 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Vehicles, including electric vehicles, can include a charging port for charging a battery of the vehicle. For example, the charging port can be configured to receive a connector of a charging station that provides electrical power. Implementations of the subject technology described herein provide for automatic actuation (e.g., opening or closing) of a vehicle charging port closure based at least in part on one or more detected conditions. For example, an ECU of a vehicle may be operated to obtain data, including sensor data from one or more sensors of the vehicle. The ECU of the vehicle may analyze the sensor data to determine a likelihood that the user will or intends to utilize the charging port, for example by opening the charging port closure to access the charging port and connect a charging connector of a charging station thereto. If the likelihood is determined to be sufficiently high, such as greater than or equal to a threshold, then the ECU can cause an actuation to open the charging port closure.

In one or more implementations, the subject system determines whether to actuate a charging port closure based on one or more factors. For example, the ECU of the vehicle may analyze battery data, such as a battery charge state and/or an amount of time since the battery was last charged. By further example, the ECU may further analyze location data, such as a location of the vehicle with respect to a charging station and/or whether the charging station is one at which charging is frequently performed. By further example, the ECU may further analyze user data, such as identifying an authorized user, determine a position and/or movement of the user with respect to the charging port closure, and/or whether the user is holding a connector configured to connect to a charging port covered by the charging port closure. Where historical user charging port closure actuation data indicates that such factors, when present, indicate that the authorized user is likely to utilize the charging port, then the ECU may determine that actuation of the charging port closure is appropriate.

Accordingly, the subject system enables automatic handsfree opening of the charging port closure, such that the vehicle charging port closure is open for providing access to the charging port. In this manner, the user can access the charging port immediately upon reaching the vehicle, such as while holding a charging connector of a charging station, and without waiting for the charging port closure to open in response to a user input or manually.

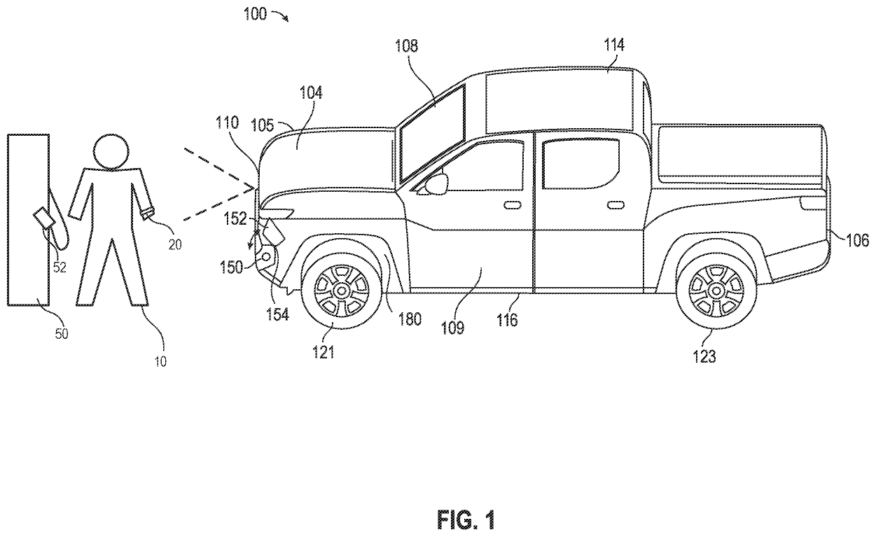

FIG. 1 illustrates an example vehicle 100 in an environment including a user 10 and a charging station 50 in a vicinity of the vehicle 100 in accordance with one or more implementations of the subject technology. As illustrated in FIG. 1, the vehicle 100 may have a front portion 104 and a rear portion 106. A cabin 108 may be located between the front portion 104 and the rear portion 106 of the vehicle 100. The cabin 108 may include entry closures, such as doors 109. There may be one, two, three, four, or five or more entry closures to the cabin 108, which may contain, for example, one or more rows of seating for human occupants. The vehicle 100 may further include a left side and right side (not shown). The left side may be referred to as a driver side of the vehicle 100, and the right side may be referred to as a passenger side of the vehicle 100 in one or more implementations. In cases where the vehicle 100 is an autonomous vehicle that does not require or is not configured for a human driver, the left side of the vehicle 100 may still be referred to as a driver side as a matter of convenience. One or more of the entry closures may be located on the left side of the vehicle 100, and one or more of the entry closures may be located on the right side of the vehicle 100.

The vehicle 100 may include a roof 114, which may include racks or other equipment for storage (not shown). In one or more implementations, the roof 114 may include a roof charging port closure (not shown), such as a sunroof, a moonroof, or the like. The vehicle 100 may further include a chassis and/or unibody 116. The vehicle 100 may further include one or more front wheels 121 and one or more rear wheels 123. In one or more implementations, the vehicle 100 may be a unibody truck, which may, for example, include a storage bed.

In one or more implementations, one or more portions of the body 105 of the vehicle 100 may be constructed of steel alloy and/or aluminum alloy or other suitable materials. The vehicle 100 may also include one or more image sensors 110. The image sensors 110 may be positioned at different locations on the vehicle 100 to capture images of different areas surrounding the vehicle 100, different fields of view, and the like.

The vehicle 100 can include a charging port 150 for receiving a charging connector that provides electrical power to a battery (not shown) of the vehicle 100 through the charging port 150. The vehicle 100 can further include a charging port closure 152 that is configured to at least partially cover and/or enclose the charging port 150 while in a closed configuration. While in the closed configuration, the charging port closure 152 can provide protection to the charging port 150, prevent access thereto, and conceal the charging port 150 from view. For example, the charging port closure 152 can form a portion of the body 105 of the vehicle 100 while in the closed configuration. The charging port closure 152 can transition to an open configuration, in which access is provided to the charging port 150. Transition of the charging port closure 152 can include changing a position and/or orientation of the charging port closure 152 with respect to the charging port 150. For example, the charging port closure 152 can slide and/or pivot to transition from the open configuration to the closed configuration or from the closed configuration to the open configuration.

The charging port closure 152 can transition from the open configuration to the closed configuration or from the closed configuration to the open configuration by one or more of a variety of mechanisms. For example, the charging port closure 152 can be transitioned by an actuator 154. The actuator 154 may include one or more devices for moving and/or controlling the charging port closure 152. The actuator 154 may be one or more types of actuators such as an electric, magnetic, mechanical, or any other type of actuator. The actuator 154 can include motors, hydraulic actuators, pneumatic actuators, magnetic actuators, piezoelectric actuators, electroactive materials, stepper motors, shape-memory alloys, and the like, as well as drivetrain components such as gears, clutches, and/or transmissions, to facilitate movement of the charging port closure 152 based on operation of the actuator 154.

The charging port closure 152 may include one or more handles, buttons, or other actuation mechanisms, and may be opened and closed by the actuator 154 and/or by manual operation from a user. For example, the user 10 can manually open or close the charging port closure 152. By further example, the user 10 can manually activate controlled actuation of the charging port closure 152 by the actuator 154. By further example, the actuator 154 can be automatically activated without manual input from the user 10. The charging port closure 152 may open and close at one or more fixed speeds and/or based on an acceleration curve (e.g., a charging port closure 152 may initially open faster than when it continues to open, and the like).

For explanatory purposes, the vehicle 100 is illustrated in FIG. 1 as a truck. However, the vehicle 100 is not limited to a truck and may also be, for example, a sport utility vehicle, a van, a delivery van, a semi-truck, an aircraft, a watercraft, a car, a motorcycle, or generally any type of vehicle or other moveable apparatus.

Also depicted in FIG. 1 is a charging station 50. The charging station 50 can include a source of electrical power to be provided to the vehicle 100. For example, the charging station 50 can include a charging connector 52 configured to connect to the charging port 150 of the vehicle 100. The charging connector 52 can access the charging port 150 when the charging port closure 152 is in the open configuration. The charging connector 52 can be connected to the charging port 150 by the user 10. The charging connector 52 and/or the charging port 150 can include attachment mechanisms to releasably secure the charging connector 52 with respect to the charging port 150 during a charging session. The charging connector 52 can be released from the charging port 150 by the user 10.

In one or more implementations, one or more factors can be considered to determine whether to actuate the charging port closure 152 of the vehicle 100. Multiple factors are described herein, and it will be understood that any one or more of such factors can be considered.

In one or more implementations, the vehicle 100 can determine whether it is stationary and/or in a parked state. Additionally or alternatively, the vehicle 100 can determine whether the user has opened a door and/or exited the vehicle. If the vehicle 100 is stationary and/or in a parked state and/or the user has opened a door and/or exited the vehicle, then the vehicle 100 may proceed with one or more other determinations (e.g., jointly or separately from the parked state determination) to determine whether to automatically open a charging port closure 152.

In one or more implementations, one or more of the image sensors 110, GPS sensors, and/or other sensors of the vehicle 100 may periodically capture location data to determine whether the vehicle 100 is in a vicinity of a charging station 50. Where the location data is captured as one or more images (e.g., by the image sensors 110), the vehicle 100 may analyze the images to determine whether a charging station 50 and/or a charging connector 52 is visible in the images. Where the location data is captured as GPS data (e.g., by the GPS sensors), the vehicle 100 may analyze the location data with respect to known charging station locations to determine whether a charging station 50 and/or a charging connector 52 is within a vicinity of the vehicle 100. Where the location data is captured by communicating directly or indirectly with the charging station 50 (e.g., by radio frequency circuity), the vehicle 100 may confirm the presence of the charging station 50 based on a self-identification provided thereby. If the charging station 50 and/or the charging connector 52 are detected by the vehicle 100, the vehicle 100 may automatically open a charging port closure 152 responsive to the detection.

In one or more implementations, the vehicle 100 can further determine whether the charging station 50 within a vicinity thereof is one of the one or more charging stations at which the vehicle 100 is frequently charged. If the charging station 50 is one at which charging is performed with sufficient frequency (i.e., satisfying a threshold), then the vehicle 100 may automatically open a charging port closure 152 responsive to the detection.

In one or more implementations, the vehicle 100 may periodically obtain battery data to determine one or more conditions relating to the battery of the vehicle. For example, the battery data can correspond to a battery charge state of the battery. If the battery charge state is sufficiently low (i.e., satisfying a threshold), then the vehicle 100 may automatically open a charging port closure 152 responsive to the detection, such as in conjunction with determining that the vehicle is near a charging station. By further example, the battery data can correspond to amount of time that has elapsed since the battery was last charged. If the amount of time is sufficiently long (i.e., satisfying a threshold), then the vehicle 100 may automatically open a charging port closure 152 responsive to the detection, such as in conjunction with determining that the vehicle is near a charging station.

Also depicted in FIG. 1 is the user 10. The user 10 may be a driver, passenger, or other user of the vehicle 100. The user 10 may be associated with the vehicle 100 as an authorized user of the vehicle 100. In one or more implementations, an authorized user may be a user that is granted permissions to access the vehicle 100 that an unauthorized user may not have. For example, an authorized user may be able to unlock the door 109 (e.g., using an authentication device 20) and/or open a charging port closure 152, but an unauthorized user may not.

In one or more implementations, the user 10 may have registered the vehicle 100 to their user account via a cloud service provider, such as provided by the manufacturer of the vehicle, and/or the user 10 may have registered one or more user-specific identifiers (e.g., biometric identifiers, user identifiers, etc.) directly with the vehicle 100. The user 10 may also have registered and/or associated an authentication device 20 with the vehicle 100, such as via the cloud service provider and/or directly with the vehicle 100. The authentication device 20 is illustrated in FIG. 1 as a wristband or watch; however, the authentication device 20 may also be a mobile device or generally any device that is capable of communicating and/or authenticating with the vehicle 100.

As another example, image(s) of the face of the user 10 may be enrolled and stored locally at the vehicle 100 and the image sensors 110 of the vehicle 100 may capture images of the user's face that may be used to identify and authorize the user 10, such as by comparing the captured images with the stored image(s).

In the scenario depicted in FIG. 1, the user 10 is approaching the charging port closure 152 of the vehicle 100. The user 10 may be approaching the vehicle 100 with the charging connector 52. Rather than waiting for the user 10 to manually actuate the charging port closure 152, the vehicle 100 may automatically actuate the charging port closure 152 in response to detecting that the user 10 is an authorized user of the vehicle 100 and that the user 10 is approaching the vehicle 100 with the charging connector 52. The charging connector 52 may be determined as approaching the vehicle 100 (e.g., the charging port closure 152) with the user 10 when the object is detected as being within a proximity of the user 10, in contact with the user 10, moving alongside the user 10, and/or is otherwise determined to be approaching the vehicle 100 coincident with the user 10 approaching the vehicle 100. The charging connector 52 may be determined as approaching the vehicle 100 (e.g., the charging port closure 152) without the user 10 being present, such as when the charging connector is configured to automatically move itself to the charging port 150. Such a determination can contribute to a determination to actuate the charging port closure 152 even when the user 10 is absent.

In one or more implementations, one or more of the image sensors 110 of the vehicle 100 may periodically capture one or more images, and the vehicle 100 may analyze the images (e.g., via facial recognition) to determine whether an authorized user (e.g., user 10) is visible in the images. The vehicle 100 may also analyze the images (e.g., via object recognition) to determine whether a charging connector 52 is detected as approaching the vehicle 100 in association with the user 10. If the user 10 and the charging connector 52 are detected by the vehicle 100, the vehicle 100 may automatically open a charging port closure 152 responsive to the detection.

Additionally or alternatively, the user 10 may be carrying (e.g., wearing, storing, or holding) an authentication device 20, such as a bracelet, key fob, authorized mobile device, and the like. The authentication device 20 may wirelessly emit authentication information corresponding to the user 10 (e.g., an authentication token and/or any cryptographic information that may be used to authenticate the user 10) that, when received and authenticated by the vehicle 100, causes an image sensor 110 of the vehicle 100 to activate and detect the charging connector 52 approaching the vehicle 100 in association with the user 10, and/or detect/recognize the face of the user 10. When the vehicle 100 determines that the charging connector 52 is approaching the vehicle 100 in association with the user 10, and/or the vehicle 100 recognizes the face of the user 10 as corresponding to an authorized user, the vehicle 100 may automatically open a charging port closure, such as the charging port closure 152.

Additionally or alternatively, a user 10 can be identified as an authorized user when the user exits the cabin 108 of the vehicle 100, approaches the charging station 50, and returns to the vehicle 100 (e.g., with the charging connector 52). When the vehicle 100 determines that the charging connector 52 is approaching the vehicle 100 in association with the user 10, and/or the vehicle 100 recognizes the user 10 as corresponding to an authorized user who recently exited the cabin 108 of the vehicle 100, the vehicle 100 may automatically open a charging port closure, such as the charging port closure 152, based at least in part on such a determination. It will be understood that such a determination can be made in combination with one or more other detections, such as battery conditions, to make an overall determination regarding actuation of the charging port closure 152.

In some embodiments, the vehicle 100 can include a suspension system 180. The suspension system 180 can be operated to control a distance between the chassis and/or unibody 116 and one or more of the front wheels 121 and/or rear wheels 123. For example, the suspension system 180 can raise and/or lower the chassis and/or unibody 116 before, during. and/or after motion of the vehicle 100. In some embodiments, the suspension system 180 can raise and/or lower the chassis and/or unibody 116 during travel to provide desired suspension properties on a given surface. Thereafter, the suspension system 180 can return the chassis and/or unibody 116 to a prior position. In some embodiments, the vehicle 100 can operate the suspension system 180 in response to a determination that a user will utilize the charging port 150. For example, the suspension system 180 can raise and/or lower the chassis and/or unibody 116 to provide convenient access to the charging port 150. Accordingly, the suspension system 180 can be operated on one or more of the factors described herein on which a determination regarding actuation of the charging port closure 152 is made. For example, a determination to actuate the charging port closure 152 can include a determination to operate the suspension system 180 to raise and/or lower the chassis and/or unibody 116.

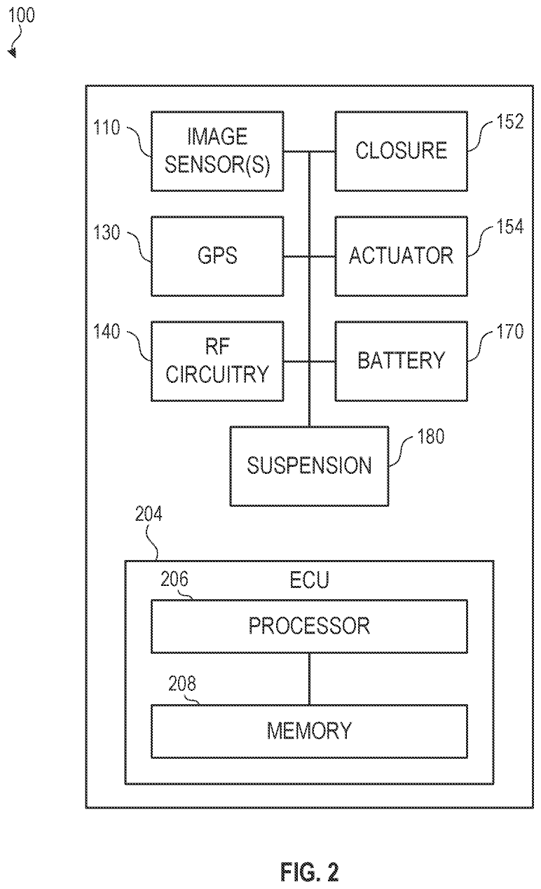

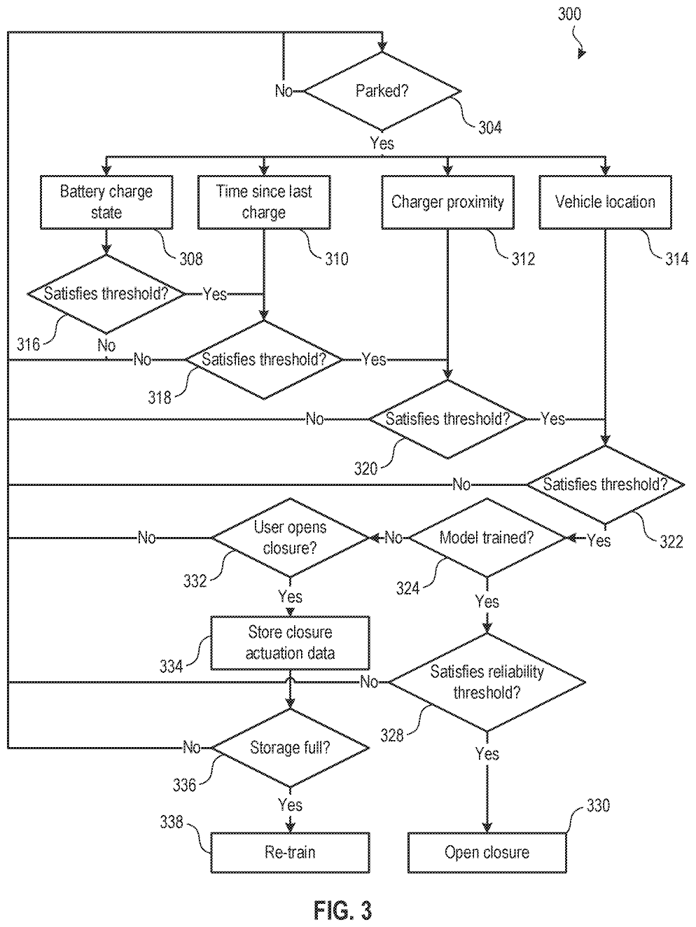

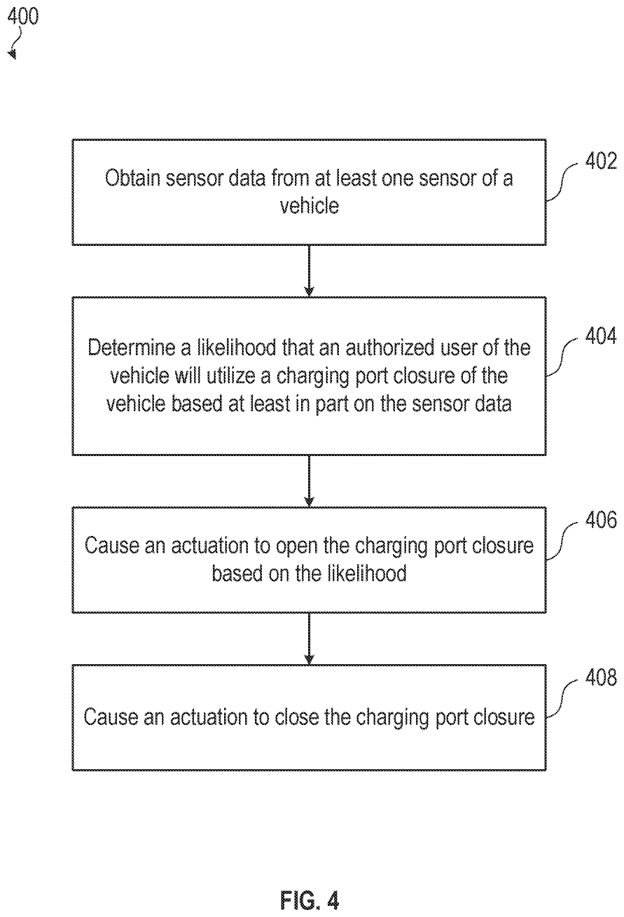

Example components of a vehicle 100 that is configured to perform automatic charging port closure actuation based on one or more detections are discussed further below with respect to FIG. 2. An example process flow for automatic charging port closure actuation based on one or more detections is discussed further below with respect to FIG. 3, and an example process for automatic charging port closure actuation based on one or more detections is discussed further below with respect to FIG. 4.

FIG. 2 illustrates a block diagram of an example vehicle 100 configured to perform automatic charging port closure actuation based on one or more detections in accordance with one or more implementations of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The vehicle 100 may include one or more ECUs 204, one or more image sensors 110, one or more GPS sensors 130, radio frequency (RF) circuitry 140, a charging port closure 152, an actuator 154, a battery 170, and a suspension system 180. The ECU 204 may include a processor 206 and a memory 208. In one or more implementations, the vehicle 100 may include a processor 206 and/or a memory 208 separate from the ECU 204. For example, the vehicle 100 may not include the ECU 204 and may include the processor 206 as a part or all of a separate semiconductor device. In one or more implementations, vehicle 100 may include multiple ECUs 204 that each control particular functionality of the vehicle 100.

The processor 206 may include suitable logic, circuitry, and/or code that enables processing data and/or controlling operations of the vehicle 100. In this regard, the processor 206 may be enabled to provide control signals to various other components of the vehicle 100, such as for example, the actuator 154. For example, the actuator 154 may receive a signal from the ECU 204 (e.g., from the processor 206 of the ECU 204), such as a signal to open or close the charging port closure 152. The processor 206 may also control transfers of data between various portions of the vehicle 100. The processor 206 may further implement an operating system, such as a real-time operating system, or may otherwise execute code to manage operations of the vehicle 100.

The memory 208 may include suitable logic, circuitry, and/or code that enable storage of various types of information such as received data, machine learning model data (such as for computer vision and/or other user/object detection algorithms), user authentication data, and/or configuration information. The memory 208 may include, for example, random access memory (RAM), read-only memory (ROM), flash, and/or magnetic storage. In one or more implementations, the memory 208 may store identifiers and/or authentication information of one or more users to determine authorized users and/or authorized authentication devices of the vehicle 100. Identifiers may include numbers, phrases, images, videos, or any other data or cryptographic information that can be associated with a user 10 and/or an authentication device 20. The memory 208 may also store account information corresponding to an authorized user for exchanging information between the vehicle 100 and a remote server. The memory 208 may also store location data, including the geographic locations of charging stations and the frequency at which one or more charging stations is used to charge the battery 170. The memory 208 may also store battery data, including an amount of time that has elapsed since the battery 170 was last charged.

The image sensor 110 may be included in one or more cameras, such as an onboard camera, dashcam, event camera, infrared camera, video camera, or any other type of device that captures digital representations of a physical environment. The cameras may be used to capture images for detecting and/or recognizing people and/or objects, such as a charging station and/or a charging connector thereof. For example, images captured by the image sensor 110 may be input into a trained facial recognition model for identifying a person, which may be compared to, for example, a database of facial data stored in the memory 208.

The RF circuitry 140 may include suitable logic, circuitry, and/or code that enables wired or wireless communication, such as locally between the vehicle 100 and a charging station, between the vehicle 100 and an authentication device 20, and/or between the vehicle 100 and one or more remote servers or devices. The RF circuitry 140 may include, for example, one or more of an ultra-wideband interface, a Bluetooth communication interface, an NFC interface, a Zigbee communication interface, a WLAN communication interface, a USB communication interface, a cellular interface, or generally any interface for transmitting and/or receiving electronic communications. The RF circuitry 140 can communicate with or otherwise detect a charging station and/or an authentication device, for example by detecting an RFID tag thereof and/or with UWB ranging.

In one or more implementations, one or more of the processor 206, the memory 208, the image sensor 110, the GPS sensor 130, the RF circuitry 140, the charging port closure 152, the actuator 154, the battery 170, the ECU 204, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices), and/or a combination of both.

FIG. 3 illustrates a flow diagram of an example process flow 300 for automatic charging port closure actuation based on one or more detections in accordance with one or more implementations of the subject technology. For explanatory purposes, the process flow 300 is primarily described herein with reference to components of the vehicle 100 of FIGS. 1 and 2. However, the process flow 300 is not limited to the vehicle 100, and one or more blocks (or operations) of the process flow 300 may be performed by one or more other components of other suitable apparatuses, devices, or systems. Further for explanatory purposes, some of the blocks of the process flow 300 are described herein as occurring in serial, or linearly. However, multiple blocks of the process flow 300 may occur in parallel. In addition, the blocks of the process flow 300 need not be performed in the order shown and/or one or more blocks of the process flow 300 need not be performed and/or can be replaced by other operations. Further for explanatory purposes, the process flow 300 is described as utilizing one or more machine learning models, such as one or more neural networks. However, the process flow 300 is not limited to utilizing a machine learning model and can also be performed using heuristics, a rules-based approach, or generally any approach.

At block 304, the vehicle 100 may be determined to be in a parked state or another state. Additionally or alternatively, the vehicle 100 may be determined to be stationary or in motion. Additionally or alternatively, one or more other conditions can be detected with respect to the vehicle 100, such as whether a motor or engine of the vehicle 100 is active or inactive and/or whether one or more other components of the vehicle 100 are active or inactive. If the vehicle 100 detects that it is in a state other than the parked state (e.g., drive, reverse, or otherwise not parked), is in motion (i.e., not stationary), and/or one or more components of the vehicle 100 are active, the vehicle 100 may determine that it is not an appropriate time to automatically open a charging port closure 152. Accordingly, the process flow 300 may restart at block 304, for example with a periodic detection with respect to block 304 and/or when a signal corresponding to the detection of block 304 is received.

If the vehicle 100 detects that it is in the parked state, is stationary (i.e., not in motion), and/or one or more components of the vehicle 100 are inactive, the vehicle 100 (e.g., via the ECU 204 and/or the processor 206) may determine whether to actuate a charging port closure based, at least in part, on one or more of a battery charge state at block 308, a time that has elapsed since the last charge at block 310, a proximity to a charging station and/or charging connector at block 312, and/or a vehicle location, including whether the charging station is one at which charging is frequently performed, at block 314.

It will be understood that a determination whether to actuate a charging port closure can be based on fewer than all of the illustrated detections. It will also be understood that a determination whether to actuate a charging port closure can be based on detections in addition to the illustrated detections. It will also be understood that a determination whether to actuate a charging port closure can be based on detections other than the illustrated detections. Furthermore, the illustrated order of detections is only one example, and detections can be considered in any order or simultaneously. While decision blocks are illustrated as leading to additional decision blocks in a particular order, it will be understood that any order can be performed and/or the decisions can be considered simultaneously. Furthermore, the results of one decision can alter the decision of another. For example, a result in one decision can be other than binary, in that the amount by which a threshold is exceeded can influence how another decision is made. By further example, multiple factors can be weighted together, such that the threshold for satisfying one factor can be lower if the threshold for another factor is satisfied by a large margin, and vice versa.

At block 308, the vehicle 100 (e.g., via the ECU 204 and/or the processor 206) can detect a battery charge state. For example, the battery charge state can include a proportion (e.g., percentage) of the total charge capacity of the battery, an amount of charge remaining (e.g., in Amp-hours), and the like. The battery charge state can be included in battery data. Such data can be collected periodically and/or when the vehicle 100 satisfies the criteria applied in block 304.

At block 310, the vehicle 100 (e.g., via the ECU 204 and/or the processor 206) can detect an amount of time that has elapsed since the battery was last charged. The last charge can be one in which the battery was charged to full (i.e., 100%) capacity, another level of charge, or any level of charge. The amount of time can be included in battery data. Such data can be collected periodically and/or when the vehicle 100 satisfies the criteria applied in block 304.

At block 312, the vehicle 100 (e.g., via the ECU 204 and/or the processor 206) can detect a proximity to a charging station and/or a charging connector. The proximity to a charging station and/or a charging connector can be included in location data. Such data can be collected periodically and/or when the vehicle 100 satisfies the criteria applied in block 304. For example, the location data can be collected by image sensors, GPS sensors, and/or other sensors of the vehicle 100. By further example, the vehicle 100 may confirm the presence of the charging station 50 by communicating with the charging station 50 via one or more communication signals. In some embodiments, the detections can include detection of an authorized user and/or an authentication device, including a determination that a given user is an authorized user. In some embodiments, the detections can include detection of a charging connector and its proximity to the charging port and/or the user, such as via computer vision and/or ultra-wideband ranging.

At block 314, the vehicle 100 (e.g., via the ECU 204 and/or the processor 206) can detect a vehicle location. The vehicle location can be included in location data. Such data can be collected periodically and/or when the vehicle 100 satisfies the criteria applied in block 304. For example, the location data can be collected by GPS sensors and/or other sensors of the vehicle 100. The location data can include or be used in concert with data indicating whether a nearby charging station is one of the one or more charging stations at which the vehicle 100 is frequently charged. Such data can be collected and updated upon each instance of charging the battery. Such data can optionally be stored in user-specific data, such that the data corresponding to frequent charging locations is specific to a given user. It will be understood that multiple charging locations can be among those at which the vehicle 100 is frequently charged. Specific frequency values can be correlated with any given charging station. Such data can further include whether charging has occurred recently and/or whether the frequency of charging at a given charging station is increasing or decreasing based on historical data.

At block 316, the battery charge state can be compared to a threshold. It will be understood that the threshold to be applied at block 316 can be based on preset data, data collected from multiple users, and/or user-specific data. If the battery charge state is not sufficiently low (i.e., not satisfying the threshold), the process flow 300 may restart at block 304 or end. Otherwise, the process flow 300 can continue to block 318. Alternatively, the process flow 300 can continue to another decision block and/or block 324.

At block 318, the amount of time that has elapsed since the battery was last charged can be compared to a threshold. It will be understood that the threshold to be applied at block 318 can be based on preset data, data collected from multiple users, and/or user-specific data. If the amount of time that has elapsed since the battery was last charged is not sufficiently long (i.e., not satisfying the threshold), the process flow 300 may restart at block 304 or end. Otherwise, the process flow 300 can continue to block 320. Alternatively, the process flow 300 can continue to another decision block and/or block 324.

At block 320, the proximity to a charging station and/or a charging connector can be compared to a threshold. It will be understood that the threshold to be applied at block 320 can be based on preset data, data collected from multiple users, and/or user-specific data. If the vehicle is not sufficiently close to a charging station and/or a charging connector (i.e., not satisfying the threshold), the process flow 300 may restart at block 304 or end. Otherwise, the process flow 300 can continue to block 322. Alternatively, the process flow 300 can continue to another decision block and/or block 324.

At block 322, the vehicle location can be compared to a threshold. It will be understood that the threshold to be applied at block 322 can be based on preset data, data collected from multiple users, and/or user-specific data. If a nearby charging station is determined to not be one at which the vehicle 100 is charged with sufficient frequency (i.e., not satisfying the threshold), the process flow 300 may restart at block 304 or end. Otherwise, the process flow 300 can continue to block 324.

At block 324, the vehicle 100 (e.g., via the ECU 204 and/or the processor 206) determines whether a machine learning model has been trained for an authorized user (as opposed to being a base machine learning model trained based on a general population of users and/or an expected general population of users). A machine learning model may be trained for an authorized user if it has been re-trained, fine-tuned, or otherwise reconfigured from a base machine learning model based on a set of user-specific charging port closure actuation data. If the machine learning model is not trained for the authorized user, the process flow 300 may move to block 332. Otherwise, the process flow 300 may move to block 328.

In one or more implementations, one or more machine learning models may be used to determine whether to open one or more charging port closures. For example, a machine learning model may be trained with data specific to the authorized user (e.g., user-specific data). User-specific data may include, for example, specific locations the user has traveled to, charging stations at which the user frequently charges the battery, battery levels at which the user frequently initiates charging, an amount of time since the last charge beyond which the user frequently initiates charging, and/or any other value relating to battery data, location data, and/or other sensor data.

For example, a machine learning model may be biased to provide an output that causes the charging port closure to be actuated based on proximity to charging stations at which the user frequently charges the vehicle's battery. For example, a charging port closure can initially be actuated based, at least in part, on a proximity to any charging station that is detected. However, over time the subject system may record geographical data regarding when particular charging stations are used to charge the battery. After re-training the model, the model may provide an output that is more heavily weighted toward actuating the charging port closure when the vehicle is in a vicinity of a charging station that is frequently used for charging the battery.

In one or more implementations, the amount of training data used to train a machine learning model may affect the machine learning model's level of reliability. When more training data is used to train a machine learning model, the machine learning model may be able to output predictions with higher degrees of certainty and/or reliability. For example, as an authorized user begins using the vehicle, weights of the machine learning model may change as the machine learning model is re-trained based on the charging port closure actuation data corresponding to the user's use of the vehicle 100. The machine learning model may become reliable at predicting when the user is likely to or intends to utilize the charging port.

In one or more implementations, the machine learning model may be re-trained directly at the vehicle 100 (e.g., via the ECU 204 and/or the processor 206). Alternatively, or in addition, the vehicle 100 may provide collected data to another computing device, such as a mobile device of the user and/or a server, to perform the model re-training. In either instance, the collection and processing of the data may be handled in accordance with user privacy best practices.

At block 332, if the machine learning model described at block 324 has not been trained for the authorized user (e.g., using user-specific charging port closure actuation data), then the charging port closure may not be automatically opened and instead the user may manually open a charging port closure (e.g., by physically pulling a handle or pressing a button). If the user does not open a charging port closure at block 332, then the process flow 300 may restart at block 304 or end.

At block 334, when the user opens a charging port closure, the vehicle 100 (e.g., via the ECU 204 and/or the processor 206) may generate charging port closure actuation data for subsequent training or re-training of a machine learning model for predicting charging port closure actuation. The data may include user-specific charging port closure actuation data such as the location where the charging port closure was opened, the battery charge state at the time the charging port closure was opened, an elapsed time since the last charge, and the like. The data may be stored with other training data for training and/or re-training (e.g., tuning, reinforcing, and the like) the machine learning model.

At block 336, if the storage (e.g., the storage that includes the training data) is full, the process flow 300 may proceed to block 338. Otherwise, the process flow 300 may restart at block 304 or end. In one or more implementations, the storage (e.g., a buffer, volume, data structure, etc.) may be a predetermined size for storing a predetermined amount of user-specific charging port closure actuation data (e.g., an amount sufficient to re-train a machine learning model, such as a base machine learning model). In one or more implementations, each authorized user may have a separate storage space for their respective user-specific charging port closure actuation data.

At block 338, a machine learning model may be trained and/or re-trained based on newly collected user-specific charging port closure actuation data. For example, the vehicle 100 may initially include, such as at the time of manufacture and/or for a new authorized user, a base machine learning model that may be trained, for example, using charging port closure actuation data corresponding to a general population of users, locations, and objects. After the vehicle 100 has accumulated a threshold amount of user-specific charging port closure actuation data relating to when and where an authorized user actuated the charging port closure, the machine learning model may be re-trained and/or refined using the user-specific charging port closure actuation data.

If the model described at block 324 is determined to be trained for the authorized user, then the process flow 300 proceeds to block 328 where the vehicle 100 (e.g., via the ECU 204 and/or the processor 206) determines whether the reliability of the charging port closure actuation prediction provided by the machine learning model satisfies a reliability threshold, in which case the predicted charging port closure is opened at block 330. In one or more implementations, the reliability of the charging port closure actuation prediction of the machine learning model may be determined based on the confidence value, or likelihood value, output by the machine learning model in conjunction with determination whether to actuate the charging port closure. If the confidence value is below a predetermined threshold, such as 0.9, or generally any threshold, the prediction of the machine learning model may be determined to be unreliable, and/or lacking the appropriate confidence, for purposes of actuating the charging port closure and the process flow 300 restarts at block 304.

In some embodiments, block 330 can include operating a suspension system to raise and/or lower the chassis and/or unibody of the vehicle. Such an action can be taken before, during, or after actuation of the charging port closure.

FIG. 4 illustrates a flow diagram of an example process 400 for automatic charging port closure actuation based on object detection in accordance with one or more implementations of the subject technology. For explanatory purposes, the process 400 is primarily described herein with reference to the vehicle 100 of FIGS. 1 and 2, and/or various components thereof. However, the process 400 is not limited to the vehicle 100 of FIG. 1, and one or more blocks (or operations) of the process 400 may be performed by one or more other structural components of the vehicle 100 and/or of other suitable moveable apparatuses, devices, or systems. Further, for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

At block 402, the vehicle 100 may obtain, by a processor (e.g., the processor 206), sensor data from at least one sensor of the vehicle 100. In some embodiments, the sensor data can include battery data. For example, the battery data can correspond to a battery charge state of the battery. By further example, the battery data can correspond to an amount of time that has elapsed since the battery was last charged.

In some embodiments, the sensor data can include location data. For example, the location data can correspond to a geographic location of the vehicle 100 and/or a proximity to a charging station, a charging connector, and/or a user. Such location and/or proximity can be directly detected, for example, by performing computer vision on an image captured by an image sensor that depicts a charging station, a charging connector, and/or a user and/or by RF circuitry communicating with a charging station and/or an authentication device. Such location and/or proximity can be inferred, for example from a detected location of the vehicle 100 by the GPS sensor and a known location of a charging station.

In some embodiments, the sensor data can include user data. The user data can correspond to an identification of a user, an identification of an authentication device associated with a user, and/or one or more historical records relating to the user's utilization of the charging port closure. Such user data can be obtained via one or more sensors of the vehicle 100 and/or by retrieval from memory of the vehicle 100 and/or another device. For example, the vehicle 100 may determine a user to be an authorized user who is authorized to interact with the vehicle 100.

At block 404, the vehicle 100 may determine, by a processor (e.g., the processor 206), a likelihood that an authorized user of the vehicle will utilize a charging port of the vehicle based at least in part on the sensor data obtained at block 402. For example, each of one or more portions of the sensor data can be compared to a corresponding threshold to determine whether that portion of the sensor data contributes to a likelihood that the authorized user of the vehicle would utilize the charging port.

Where multiple factors are considered, the results of one comparison to a corresponding threshold can alter how another factor is considered or otherwise contributes to a final determination. For example, multiple factors can be weighted together, such that the threshold for satisfying one factor can be lower if the threshold for another factor is satisfied by a large margin, and vice versa. As such, no single factor need be fully dispositive to a determination of whether to actuate the charging port closure.

In one or more implementations, the ECU 204 and/or the processor 206 of the vehicle 100 may predict whether the user will or intends to utilize the charging port using a machine learning model. As previously discussed, the vehicle 100 may initially include a base machine learning model (e.g., stored in memory 208) for which the training data set may include charging port closure actuation data corresponding to a general population of different users and/or different objects.

As the authorized user uses the vehicle 100, the vehicle 100 may collect user-specific charging port closure actuation data relating to when and where the authorized user actuated the charging port closure and/or what sensor data (e.g., location data, battery data, user data) was applicable at the time. For example, user-specific charging port closure actuation data may include the time, location, battery charge state, elapsed time since last charge, proximity to charging station and/or charging connector with an indication of whether a charging port closure was actuated by the user. The base machine learning model may then be re-trained and/or refined using the collected user-specific charging port closure actuation data and then may be used to predict whether the user will or intends to utilize the charging port based on one or more of the aforementioned input features (e.g., location, detected object, etc.), and may provide a likelihood associated therewith.

If the likelihood exceeds a threshold value (e.g., 90%), then the ECU 204 and/or the processor 206 of the vehicle 100 may cause the actuation of the charging port closure. After the actuation, the ECU 204 and/or processor 206 of the vehicle may store a new data point indicating whether the user actually intended for the charging port closure to actuate, such as based on whether receipt of the charging connector at the charging port occurs as detected by a sensor and/or the receipt of electrical power. In one or more implementations, a confirmation that the user intended for the charging port closure to be actuated may be received via an affirmative confirmation from the user (e.g., a dashboard prompt for the user to indicate confirmation) and/or an inferred confirmation (e.g., connection of charging connector and/or transfer of power). The new data may be added to the collected user-specific charging port closure actuation data to subsequently re-train and/or refine the machine learning model for future charging port closure actuation predictions.

At block 406, the ECU 204 and/or processor 206 of the vehicle 100 may cause an actuation to open the charging port closure. For example, the ECU 204 and/or the processor 206 may transmit a command and/or signal to the actuator 154 to actuate the charging port closure 152 such that it transitions to an open configuration. The charging port closure 152 can remain open until one or more conditions is detected as described further herein.

At block 408, the ECU 204 and/or processor 206 of the vehicle 100 may cause an actuation to close the charging port closure. For example, the ECU 204 and/or the processor 206 may transmit a command and/or signal to the actuator 154 to actuate the charging port closure 152 such that it transitions to a closed configuration. In some embodiments, the charging port closure 152 can close when charging is inferred to be complete. For example, the charging port closure can be closed upon detection of a removal of the charging connector, a cessation of charging, and/or movement of the charging connector and/or the user away from the charging port. In some embodiments, the charging port closure can be closed when a lack of activity is detected. For example, the charging port closure 152 can close when an amount of time has elapsed without connecting the charging connector to the charging port. By further example, the charging port closure 152 can close when the user does not approach the charging port or moves away from the charging port. Where the detected conditions indicate that the user will not or does not intend to utilize the charging port, the model may then be re-trained and/or refined as described herein.

In some embodiments, block 408 can include operating a suspension system to raise and/or lower the chassis and/or unibody of the vehicle. Such an action can be taken before, during, or after actuation of the charging port closure.

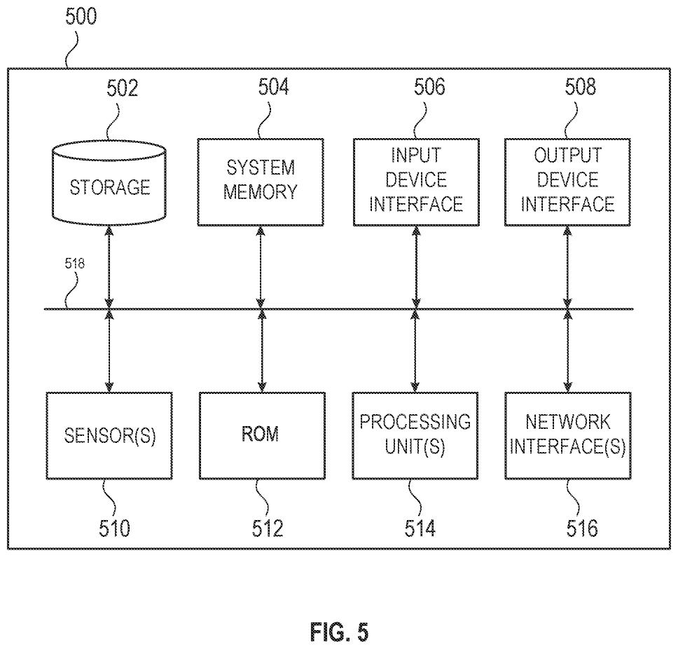

FIG. 5 illustrates an example electronic system 500 with which aspects of the present disclosure may be implemented. The electronic system 500 can be, and/or can be a part of, any electronic device for providing the features and performing processes described in reference to FIGS. 1-4, including but not limited to a vehicle, computer, server, smartphone, and wearable device (e.g., authentication device). The electronic system 500 may include various types of computer-readable media and interfaces for various other types of computer-readable media. The electronic system 500 includes a persistent storage device 502, system memory 504 (and/or buffer), input device interface 506, output device interface 508, sensor(s) 510, ROM 512, processing unit(s) 514, network interface 516, bus 518, and/or subsets and variations thereof.

The bus 518 collectively represents all system, peripheral, and chipset buses that communicatively connect the numerous internal devices and/or components of the electronic system 500, such as any of the components of the vehicle 100 discussed above with respect to FIG. 2. In one or more implementations, the bus 518 communicatively connects the one or more processing unit(s) 514 with the ROM 512, the system memory 504, and the persistent storage device 502. From these various memory units, the one or more processing unit(s) 514 retrieves instructions to execute and data to process in order to execute the processes of the subject disclosure. The one or more processing unit(s) 514 can be a single processor or a multi-core processor in different implementations. In one or more implementations, one or more of the processing unit(s) 514 may be included on an ECU 204, such as in the form of the processor 206.

The ROM 512 stores static data and instructions that are needed by the one or more processing unit(s) 514 and other modules of the electronic system 500. The persistent storage device 502, on the other hand, may be a read-and-write memory device. The persistent storage device 502 may be a non-volatile memory unit that stores instructions and data even when the electronic system 500 is off. In one or more implementations, a mass-storage device (such as a magnetic or optical disk and its corresponding disk drive) may be used as the persistent storage device 502.

In one or more implementations, a removable storage device (such as a floppy disk, flash drive, and its corresponding disk drive) may be used as the persistent storage device 502. Like the persistent storage device 502, the system memory 504 may be a read-and-write memory device. However, unlike the persistent storage device 502, the system memory 504 may be a volatile read-and-write memory, such as RAM. The system memory 504 may store any of the instructions and data that one or more processing unit(s) 514 may need at runtime. In one or more implementations, the processes of the subject disclosure are stored in the system memory 504, the persistent storage device 502, and/or the ROM 512. From these various memory units, the one or more processing unit(s) 514 retrieves instructions to execute and data to process in order to execute the processes of one or more implementations.

The persistent storage device 502 and/or the system memory 504 may include one or more machine learning models. Machine learning models, such as those described herein, are often used to form predictions, solve problems, recognize objects in image data, and the like. For example, machine learning models described herein may be used to predict whether an authorized user is approaching a vehicle and intends to open a charging port closure. Various implementations of the machine learning model are possible. For example, the machine learning model may be a deep learning network, a transformer-based model (or other attention-based models), a multi-layer perceptron or other feed-forward networks, neural networks, and the like. In various examples, machine learning models may be more adaptable as machine learning models may be improved over time by re-training the models as additional data becomes available.

The bus 518 also connects to the input device interfaces 506 and output device interfaces 508. The input device interface 506 enables a user to communicate information and select commands to the electronic system 500. Input devices that may be used with the input device interface 506 may include, for example, alphanumeric keyboards, touch screens, and pointing devices. The output device interface 508 may enable the electronic system 500 to communicate information to users. For example, the output device interface 508 may provide the display of images generated by electronic system 500. Output devices that may be used with the output device interface 508 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 518 also connects to sensor(s) 510. The sensor(s) 510 may include a location sensor, which may be used in determining device position based on positioning technology. For example, the location sensor may provide for one or more of GNSS positioning, wireless access point positioning, cellular phone signal positioning, Bluetooth signal positioning, image recognition positioning, and/or an inertial navigation system (e.g., via motion sensors such as an accelerometer and/or gyroscope). In one or more implementations, the sensor(s) 510 may be utilized to detect movement, travel, and orientation of the electronic system 500. For example, the sensor(s) may include an accelerometer, a rate gyroscope, and/or other motion-based sensor(s). The sensor(s) 510 may include one or more biometric sensors and/or image sensors for authenticating a user.

The bus 518 also couples the electronic system 500 to one or more networks and/or to one or more network nodes through the one or more network interface(s) 516. In this manner, the electronic system 500 can be a part of a network of computers (such as a local area network or a wide area network). Any or all components of the electronic system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different orders. Some of the steps, operations, or processes may be performed simultaneously. The accompanying method claims, if any, present elements of the various steps, operations, or processes in a sample order, and are not meant to be limited to the specific order or hierarchy presented. These may be performed in serial, linearly, in parallel, or in different order. It should be understood that the described instructions, operations, and systems can generally be integrated together in a single software/hardware product or packaged into multiple software/hardware products.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A method comprising:
obtaining, by a processor, sensor data from at least one sensor of a vehicle;
determining, by the processor, a likelihood that an authorized user of the vehicle will utilize a charging port of the vehicle based at least in part on the sensor data; and
causing, by the processor, an actuation to open a charging port closure based on the likelihood.

2. The method of claim 1, wherein the sensor data corresponds to a battery charge state of a battery of the vehicle.

3. The method of claim 1, wherein the sensor data corresponds to an amount of time since a battery of the vehicle was last charged.

4. The method of claim 1, wherein the sensor data corresponds to a proximity of the vehicle to a charging connector that is configured to connect to the charging port covered by the charging port closure.

5. The method of claim 1, wherein the sensor data corresponds to a proximity to one of one or more locations at which the vehicle is most frequently charged.

6. The method of claim 1, wherein the sensor data corresponds to a proximity of the authorized user to the charging port closure.

7. The method of claim 1, wherein the sensor data corresponds to a detection that the authorized user is holding a charging connector that is configured to connect to the charging port covered by the charging port closure.

8. The method of claim 1, further comprising:
after causing the actuation to open the charging port closure and by the processor, determining that an amount of time has elapsed; and
causing another actuation to close the charging port closure based on the amount of time.

9. The method of claim 1, further comprising:
obtaining a base machine learning model, the base machine learning model having been trained based on charging port closure actuation data corresponding to multiple of additional users and multiple additional vehicles.

10. The method of claim 9, wherein:
the likelihood that the authorized user of the vehicle will utilize the charging port of the vehicle is determined further based on the base machine learning model; and
the actuation is caused when the likelihood exceeds a threshold value.

11. The method of claim 10, further comprising:
collecting user-specific charging port closure actuation data corresponding to the authorized user and the vehicle; and
refining the base machine learning model based at least in part on the user-specific charging port closure actuation data.

12. A semiconductor device comprising:
circuitry configured to:
obtain battery data corresponding to a battery of a vehicle, the battery data comprising a battery charge state of the battery and an amount of time since the battery was last charged;
determine a likelihood that an authorized user of the vehicle will utilize a charging port of the vehicle based at least in part on the battery data; and
cause an actuation to open a charging port closure based on the likelihood.

13. The semiconductor device of claim 12, wherein the circuitry is further configured to obtain location data corresponding to a location of the vehicle with respect to a charging station, wherein determining the likelihood that the authorized user will utilize the charging port is further based at least in part on the location data.

14. The semiconductor device of claim 12, wherein the circuitry is further configured to obtain user data corresponding to a location of the authorized user with respect to the charging port closure, wherein determining the likelihood that the authorized user will utilize the charging port is further based at least in part on the user data.

15. A non-transitory machine-readable medium storing instructions that, when executed by one or more processors, cause the one or more processors to perform operations comprising:
obtaining sensor data from at least one sensor of a vehicle, the sensor data corresponds to a condition of a battery of the vehicle and a location of the vehicle;
determining a likelihood that an authorized user of the vehicle will utilize a charging port of the vehicle based at least in part on the sensor data; and
causing an actuation to open a charging port closure based on the likelihood.

16. The non-transitory machine-readable medium of claim 15, wherein the condition of the battery is charge state of the battery.

17. The non-transitory machine-readable medium of claim 15, wherein the condition of the battery is amount of time since the battery was last charged.

18. The non-transitory machine-readable medium of claim 15, wherein the location of the vehicle indicates a proximity of the vehicle to a charging connector that is configured to connect to the charging port.

19. The non-transitory machine-readable medium of claim 15, wherein the location of the vehicle indicates a proximity to one of one or more locations at which the vehicle is most frequently charged.

20. The non-transitory machine-readable medium of claim 15, wherein the sensor data corresponds to a proximity of the authorized user to the charging port closure.
